(19) United States
(12) Patent Application Publication
(10) Pub. No.: US 2019/0325156 A1
(43) Pub. Date: Oct. 24, 2019

(54) SYSTEM AND METHOD FOR REMOTELY DELETING DATA FROM A CLIENT DEVICE

(71) Applicants: QIANG JASON DU, North Potomac, MD (US); Guan Lunzai, Chengdu (CN); Wu Gang, Chengdu (CN)

(72) Inventors: QIANG JASON DU, North Potomac, MD (US); Guan Lunzai, Chengdu (CN); Wu Gang, Chengdu (CN)

(21) Appl. No.: 16/390,247

(22) Filed: Apr. 22, 2019

Related U.S. Application Data
(60) Provisional application No. 62/660,783, filed on Apr. 20, 2018.

(51) Int. Cl. G06F 21/62; G06F 16/23

(52) U.S. Cl. CPC G06F 21/6218; G06F 16/2379

(57) ABSTRACT

Embodiments described herein include an application, system, and method for sending data from a first electronic device to a second electronic device, requesting deletion of the data by a first user of the first electronic device, and deleting the data from the second electronic device.

### PRIORITY

The instant application claims priority to U.S. Provisional Application No. 62/660,783, filed Apr. 20, 2018, which is incorporated by reference in its entirety herein.

### BACKGROUND

There are a number of social sharing applications, websites, and programs. For example, a social application may include a software program downloaded to a user's device that permits them to identify friends. The friends may also include a software program downloaded on their respective devices. The software program run on each device may be configured so that a user may enter in or select text, audio, images, video, or other electronic data and transmit the data to one or more identified users. The software program may be configured to take the data and communicate the data over a network to the software program of the other user(s). The software program of the other user then receives and displays or plays the received data to the receiving user.

### BRIEF SUMMARY

Embodiments described herein include an application, system, and method for sending data from a first electronic device to a second electronic device, requesting deletion of the data by a first user of the first electronic device, and deleting the data from the second electronic device.

Exemplary embodiments permit the deletion of data regardless of the status of the data in relation to the second user and/or second electronic device. For example, the data may be deleted after the data is retrieved and stored on a second electronic device, after the data is viewed by a second user of the second electronic device, before the data is retrieved by the second electronic device, or at any time after the data is sent from the first electronic device.

### BRIEF DESCRIPTION OF THE DRAWINGS

FIGS. 1A-1B illustrates exemplary methods for sending and retrieving data according to embodiments described herein.

FIGS. 2A-2C illustrates an exemplary process diagrams for sending and retrieving data according to embodiments described herein.

FIG. 3 illustrates an exemplary system according to embodiments described herein.

### DETAILED DESCRIPTION

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

Embodiments described herein include an application, system, and method for sending data from a first electronic device to a second electronic device, requesting deletion of the data by a first user of the first electronic device, and deleting the data from the second electronic device.

Exemplary embodiments permit the deletion of data regardless of the status of the data in relation to the second user and/or second electronic device. For example, the data may be deleted after the data is retrieved and stored on a second electronic device, after the data is viewed by a second user of the second electronic device, before the data is retrieved by the second electronic device, or at any time after the data is sent from the first electronic device.

Many programs permit the exchange of data between users. For example, there are chat programs, text programs, social networking platforms, etc. Conventionally, more than one copy of any shared data may be created or retained within the system when information is exchanged between users. For example, a copy may exist at the sending user's device, at the communication server that facilitates transmission from one device to another, and/or at the receiving user's device. If a user deletes data that was sent to another user, conventionally, only that user's copy is deleted. In the alternative, even if a single copy is retained, such as at a remote server, the pointer to that information that permits a user to access the information may be deleted. However, the deletion by one user does not have any effect on the copies or the ability held by others to access the shared data.

There may be instances when a user has sent a message, video, audio, picture, or other data to another user, and the user wants to retrieve or delete that data not only in their own system but permanently so that no one has future access to the data. For example, when a relationship may have ended between social partners, one or both individuals may want the data shared with the other person to be removed and not accessible any longer by the other person. It may be that during a relationship, personal information is shared that the sending person no longer wants the receiving person to have access to. Shared information can also be used in different ways to tarnish the reputation of the sending person. It may be that the sender may simply want their data returned or not accessible by another person.

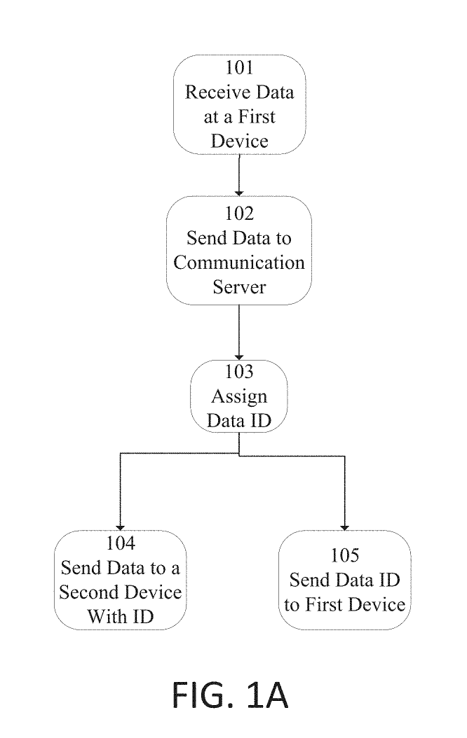

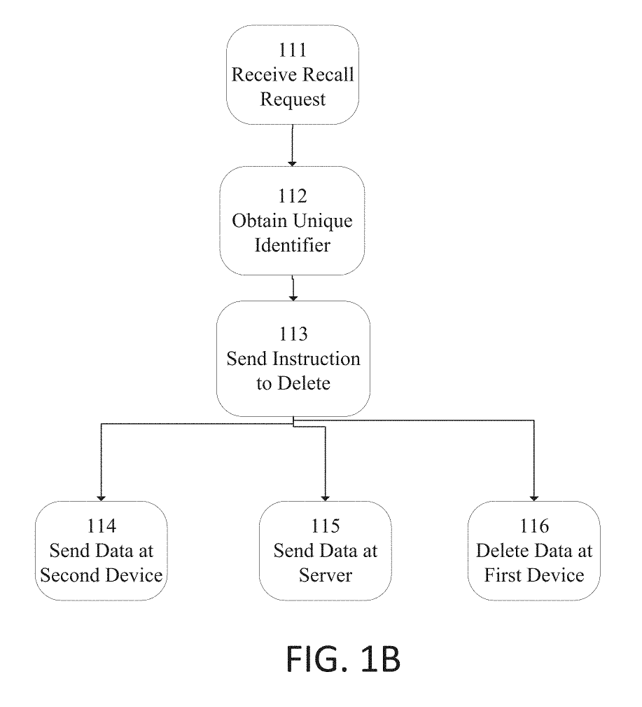

FIGS. 1A-1B illustrates an exemplary methods for sending, receiving, and/or recalling data according to embodiments described herein.

FIG. 1A illustrates an exemplary method of sending data from a first device to a second device. At step 101, a first device receives data. The first device may receive data from different sources. For example, a user of the first device may use components of the first device to generate the data. The user may generate the data by entering in inputs on a user input device, such as a keyboard, audio receiver, and/or image receiver. The user may generate the data by taking a picture or a video using a camera associated with the device. The user may generate the data by taking a recording using a microphone associated with the device. The user may enter information, such as text, characters, stickers, images, etc. through a user input device on or connected to a first device. The first device may also receive data from other sources. For example, the first device may include a communication port for receiving data, such as from a memory location, network, or other device. The user may therefore navigate a user interface on the first device and connect to a local or remote location to retrieve data. For example, a user may select data from the first device, from an input device (such as an attached storage device), and/or from a remote location (such as the cloud). The user may use the user input device on or connected to the first device to select one or more files, such as video, image, photo, text, etc. or combinations thereof.

At step 102, the system may take the data from step 101 send it to a server. The server may store a local copy of the data or hold the data for transmission to the second device.

Once received at the server, at step 103, the system may provide an identifier for the received data. The server may generate a unique identifier for uniquely identifying the data. The server may assign a unique identifier based on any combination of factors or in any way. For example, each data communication may receive an individually assigned, unique identification alpha-numeric code. The unique identifier may also be generated based on the sending user, the sending device, the receiving user, the receiving device, the type of data, the sending information, the receiving information, and any combination thereof. For example, part of a unique identifier may include an identification of the sending user. For example, part of a unique identifier may include an identification of the type of data, such as a text, image, video, audio, or other data file type. For example, a part of a unique identifier may include a date or time stamp of sending and/or receiving information. For example, a part of the unique identifier may include a sequential, random, or available number to uniquely identify the data.

At step 104, the system may send the data from the server to a second user to be received and provided to the second user through a second electronic device. The data may be provided to the second user through any output device on any second electronic device. For example, a second output device may include a display and/or a speaker. Exemplary second electronic device may include a mobile phone, tablet, screen, smart watch, computer, laptop, etc. When the data is sent to the second electronic device, the system is configured to identify the data with the unique identifier. Therefore, the sent data can be tagged or associated with the data identifier. The sent data may then be received and consumed by the user at the second electronic device. The data can reside at the second electronic device of the second user and be observed by the second user through an output device of, attached to, or otherwise associated with the second electronic device. The data may be observed, such as through an output display, audio speakers, touch interface, or other output device in which the second user may retrieve the data from the first user. The data may reside or be stored locally at the second electronic device and/or may be stored remotely at the server or other location and retrieved and displayed or provided to the user through a communication link between the remote location and the second electronic device.

At step 105, the system may provide the unique data identifier to the first electronic device. The server may send the unique data identifier after the server sends the data to the second device at step 104. The receipt of the unique data identifier at the first electronic device may act as confirmation that the transmission of data was successful. The unique identifier may be associated with the data at the first electronic device.

FIG. 1B illustrates an exemplary request to recall data sent by the first user to the second user. At step 111, a first user may request the recall of a particular data or string of data. For example, a user may indicate an entire exchange with another user, and/or may select individual messages, files, or information exchanged with another user. The system may be configured to retrieve the unique identifiers associated with the identified data exchanges. In an exemplary embodiment, the first user may use an input device of or associated with the first electronic device to indicate a data for deletion on another device. For example, the system may be configured to display to the user one or more data sent between the first user and/or the second user. The data may be stored locally at the first device and/or retrieved and displayed from a remote location, such as a remote server. The system may be configured to receive an input from the user indicating a desire to delete a data. The system may receive an input from a user such as through a keypad or touch screen indicating a delete input to the system. The delete input may be a user input through a virtual or physical keypad or button, such as a touch received at a virtual icon of a trash icon or in a delete button on a user interface. The system may display one or more prompts to the user to confirm the intention to delete one or more data. For example, the system may be configured to display to a user a request to confirm or cancel the deletion of the instant data, and/or may request whether the user intends to delete additional data, such as an entire exchange between the first and second users, or a subset of an exchange between first and second users. The system may be configured to receive one or more inputs from the user to identify and/or confirm the intent of the first user to delete one or more data from the system. Once one or more data are identified to be deleted, the user can confirm the intent to recall data sent to another user.

At step 112, the system may be configured to determine one or more unique identifiers associated with the one or more data to be deleted. The system may retrieve the unique identifier directly from the first user device if the unique identifier is associated with the data at the first user device. The system may retrieve the unique identifier from the server by identifying the data to the server, the server looking up the data, and the server returning the unique identifier to the first device.

At step 113, the system may be configured to generate a recall message instruction identifying the identification number(s) associated with the request. The recall message may originate from the first user device based on the unique identifier, and/or may originate from the server. In an exemplary embodiment, the recall request identifying the unique identifier is sent to the server from the first electronic device and relayed to the recipient device, the second electronic device.

At steps 114, 115, 116, the data associated with the unique identifier are deleted from the first electronic device, the second electronic device, and the communication server and/or database of the system. The system may be configured to delete the data from any combination of devices, such as multiple user devices associated with the first or second user and/or in any combination of memory locations of the system and/or database associated with the system. In an exemplary embodiment, the user may select to delete data or remove access to the data to the second user but may retain access for themselves. In this case, the system may be configured to delete data at the second device, but not delete the data at the first device. In an exemplary embodiment, the system may be configured to send and/or receive confirmations that the data is deleted from any combination of the first device, second device, the communication server, and/or database. The system may be configured to delete or remove any copy of the data, and/or delete or remove any pointer to the data prohibiting access to the data associated with the identification number(s) from any combination of storage locations, such as the first electronic device, the second electronic device, the server, the database, or other system component. At step 114, the system may be configured to delete any data associated with the identifier held in memory on the second electronic device. The system may be configured to inform the user of the deletion and/or may inform another component of the system and/or another user of the system. For example, a confirmation of deletion may be sent from the second electronic device to the server, and/or the first electronic device. At step 115, the system may be configured to delete any data associated with the identifier held in memory at the system server and/or system database. The system may be configured to inform the user of the deletion. At step 116, the system may be configured to delete any data associated with the identifier held in memory on the first electronic device. The system may be configured to inform the user of the deletion. Any combination of steps 114, 115, and 116 may be optionally implemented, such that data may be retained in one or more locations and deleted from one or more other locations.

In an exemplary embodiment, a user may be informed of a deletion through different notification methods. For example, the user may be sent a text message, e-mail, in application message such as one displayed within a tab/window/section of an application notification, a pop-up message, or other form of output to indicate the deletion may have occurred. The application may retain the display location of the original data and change the user output image associated with the data to indicate its deleted status. For example, a text message list may replace the data with a display of DELETED, or other identifier.

The system may also be configured to look for and retrieve and/or delete data from multiple electronic devices retained by the user(s). For example, the server may retain a device identifier for a user that indicates the one or more devices the user may use to access the system. The system may be configured to send deletion requests based on the identifier of the data to be deleted as well as on device identifiers. In this way, a plurality of deletion requests may be sent and confirmed to ensure or improve the chances that multiple copies retained by a user across multiple devices are deleted.

In an exemplary embodiment, a user may have already deleted or removed data from their device and/or system. If the first user (the data originator or sender) no longer has the data saved or available on the first device or any device presently in control of the first user, the user may request to delete data sent by that user. The request may identify data attributes such as date it was created, date it was sent, date it was last edited, recipient of the data, file type, or other identifiable information or attribute that may be used to locate the data to be deleted. The request may be sent from the first electronic device of the first user to the server. The server may thereafter perform a look up in any database in communication with the server. The data or additional attributes or information about the data may be returned to the Client A device of the first user. The returned attributes may include the identifier(s) associated with the data and created during the method illustrated in FIG. 1A. The first electronic device may thereafter have the data or sufficient information about the data to initiate a request similar to that explain herein with respect to a deletion request. The user may be able to identify the data to be deleted; the user may initiate the request; the system may send a request to delete identifying identifier(s) associated with the data to the server; the server may send a request to a second electronic device including the identifier(s) associated with the data; the system may delete the data associated with the identifier(s) from the second electronic device; the system may delete the data associated with the identifier(s) from the server or other databases or memory associated with or in communication with the server; the system may delete the data associated with the identifier(s) from the first electronic device.

The identifiers described herein may be the unique identifiers originally assigned to the data and/or another identifier to identify one or more sets of data to be deleted. For example, if any identifier is generated based on data attributes, such as sender, recipient, time, date, and combinations thereof, the identifier used to identify data to be deleted may be a subset of the unique identifier, such that a single delete instruction may encompass a plurality of data. The request to recall a message may include all data associated with a sender to a recipient. In this case, the system may receive an identifier including the portion of the unique identifier for the sender and recipient. The system may then be configured to delete any data having a unique identifier in common with the portion of the identifier, which may encompass multiple unique identifiers. The system may be configured to determine a plurality of unique identifiers in common with the identifier and send multiple delete requests based on each unique identifier. The system may therefore be configured to handle the delete request in different ways.

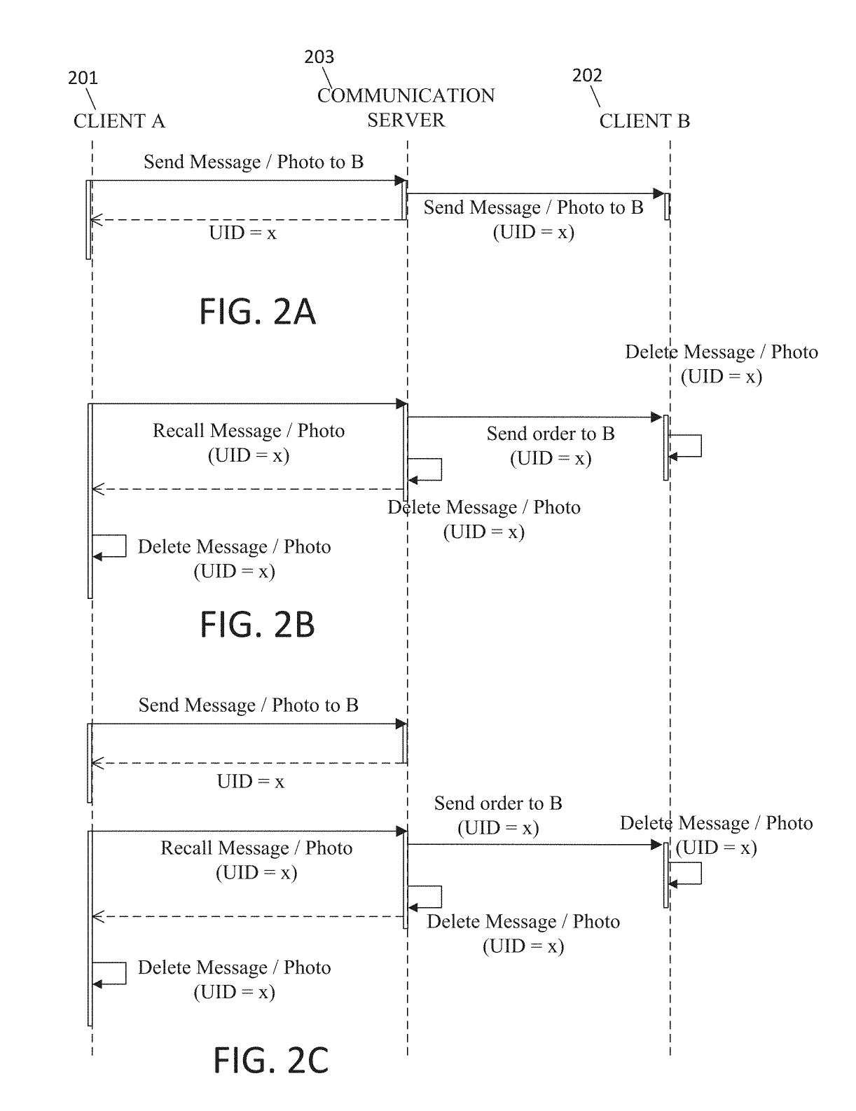

FIGS. 2A-2C illustrates exemplary process diagrams for sending, receiving, and/or recalling data according to embodiments described herein. As shown, Client A, 201 represents a first electronic device associated with a first user, where the first electronic device is configured to receive input from the first user and send/receive data over a communication path or network. Client B, 202 represents another electronic device associated with a second user configured to receive data over a communication path or network and present data (such as through a speaker, visual display screen, or other device output device) to the other user. Communication Server 203 represents a remote server for receiving and sending data communications between user client devices, such as an instant messaging (IM) service. Exemplary embodiments of the system described herein include methods and processes of sending, retrieving, deleting data, and combinations thereof, between client A and client B through a communication server.

FIG. 2A illustrates an exemplary process of sending data from client A to client B through the communication server. In an exemplary embodiment, a user A may use a client device, client A, such as a mobile device, computer device, or other electronic device to send data. In an exemplary embodiment, the client device, client A, may have an application downloaded and saved to the client device that when executed by the process in configured to receive inputs from the user and implement the communications including sending and receiving data and instructions as described herein. The application may be configured to present the user with a user interface for receiving information, instructions, and/or directions. The application may also be configured to receive data for communication to a remote device, such as client B and/or to communication server 203. The application may be resident on the client device and/or accessible by the client device. For example, the application may be a remote application executed by a browser configured to display the user interface on a screen of the electronic device, client A.

The user may enter information, such as text, characters, stickers, images, etc. through a user input device on or connected to a first user device, client A. The user may also or alternatively select data from the client A device, from an input device (such as an attached storage device), and/or from a remote location (such as the cloud). The user may use the user input device on or connected to the first user device to select one or more files, such as video, image, photo, text, etc. or combinations thereof. The system may take the entered or retrieved data identified by the user and send it to a server. For example, the user may operate through a first application either resident on the client A device or accessible and configured to communicate through the client A device, such as on a browser. The first application may be configured to receive data from the user and send the data to a server. Once received at the server, the server may provide a unique identifier for the received data. The server may provide this unique identifier back to the first electronic device, Client A. The unique identifier may act as confirmation that the transmission of data was successful. The unique identifier may be associated with the data at the first electronic device. The server may then send the data from the server to a second user to be received and provided to the second user through a second electronic device (such as a mobile phone, tablet, screen, smart watch, computer, laptop, etc.). The sent data can be tagged or associated with the unique identifier. The sent data may then reside at the Client B device of the second user and be observed by the second user through an output device of, attached to, or otherwise associated with the second electronic device. The data may be observed, such as through an output display, audio speakers, touch interface, or other output device in which the second user may retrieve the data from the first user. The data may be stored, and/or displayed, and/or provided to the second user through a second application either resident or accessible by the second electronic device, client B. Similar to the first application, the second application may be configured to send and receive information and/or data to another device and/or to a communication server and/or display or receive information through user input and output devices of the electronic device to a user of the electronic device. Similar to the first application, the second application may be downloadable and resident in the memory of the electronic device and executed by a processor of the electronic device and/or accessible by the electronic device such as over a browser.

FIG. 2B illustrates an exemplary request to recall data sent by the first user to the second user. The user may request the recall of a particular data or string of data. For example, a user may indicate an entire exchange with another user, and/or may select individual messages, files, or information exchanged with another user. The system may be configured to retrieve the unique identifier(s) associated with the identified data exchanges. Once identified, the user can confirm the intent to recall data sent to another user. The system may generate a recall message instruction identifying the identifier(s) associated with the request. The recall message is sent to the server and relayed to the recipient device, Client B. The application at the Client B device is configured to delete any data associated with the identifier(s). The application may be configured to display or provide a notice to the second user of the deletion of data from the Client B device. The application at the Client B device may be configured to send a confirmation indicator to the server of data deletion. If data is retained at the server or other memory outside of the Client A and Client B devices, the system may be configured to delete or remove any copy of the data associated with the identifier(s) from these storage locations. At step three, the application on the local device, Client A, of the first user may be configured to delete any data associated with the identification number(s) held in memory on the first electronic device. The system may be configured to inform the user of the deletion.

In an exemplary embodiment, a user may be informed of a deletion through different notification methods. For example, the user may be sent a text message, e-mail, in application message such as one displayed within a tab/window/section of an application notification, a pop-up message, or other form of output to indicate the deletion may have occurred. The application may retain the display location of the original data and change the user output image associated with the data to indicate its deleted status. For example, a text message list may be shown to a user with the messages deleted by the sender shown as REMOVED BY SENDER or other indication of being deleted, recalled, or removed.

The system may also be configured to look for and retrieve and/or delete data from multiple electronic devices retained by the user(s). For example, the server may retain a device identifier for a user that indicates the one or more devices the user may use to access the system. The system may be configured to send deletion requests based on the identifier(s) of the data to be deleted as well as on device identifiers. In this way, a plurality of deletion requests may be sent and confirmed to ensure or improve the chances that multiple copies retained by a user across multiple devices are deleted.

In an exemplary embodiment, a user may have already deleted or removed data from their device and/or system. FIG. 2C is an exemplary embodiment in which a user initiates a request and the unique identifier is not found. If the first user (the data originator or sender) no longer has the data saved or available on the first device (Client A) or any device presently in control of the first user, the user may request to delete data sent by that user. The request may identify data attributes such as date it was created, date it was sent, date it was last edited, recipient of the data, file type, or other identifiable information or attribute that may be used to locate the data to be deleted. The request may be sent from the first electronic device of the first user to the server. The server may thereafter perform a look up in any database in communication with the server. The data or additional attributes or information about the data may be returned to the Client A device of the first user. The returned attributes may include the unique identifier(s) associated with the data and created during the process illustrated in FIG. 2A. The first electronic device may thereafter have the data or sufficient information about the data to initiate a request similar to that explain above with respect to FIG. 2B. The user may be able to identify the data to be deleted; the user may initiate the request; the system may send a request to delete identifying identification number(s) associated with the data to the server; the server may send a request to a second electronic device including the identification number(s) associated with the data; the system may delete the data associated with the identification number(s) from the second electronic device; the system may delete the data associated with the identification number(s) from the server or other databases or memory associated with or in communication with the server; the system may delete the data associated with the identification number(s) from the first electronic device.

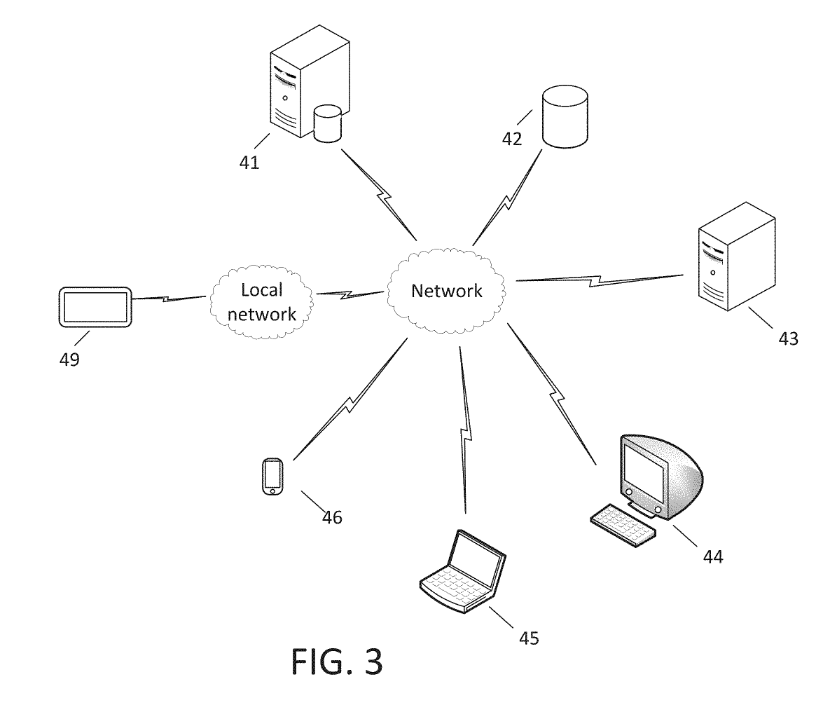

FIG. 3 illustrates an exemplary system according to embodiments described herein. A user may access the system through one or more electronic devices such as mobile phone 46, laptop 45, computer 44, tablet 49, etc. The electronic device may have memory and a processor. The memor(y/ies) may include non-transitory machine readable instructions stored thereon that when executed by a processor(s) perform functions described herein. The one or more electronic devices may have an application stored thereon that is configured to receive and send data over a communication network to another electronic device. The communication network may be any system for communicating, sending, receiving, and combinations thereof of electronic data, such as cellular networks, internet, local area networks, etc., and combinations thereof. The application may be configured to present information to the user through one or more output devices associated with (on, attached to, or communicatively coupled to) the electronic device. The application may be configured to receive information from a user through one or more input devices associated with the electronic device. The application may be configured to communicate data over a network. In an exemplary embodiment, the system may include process, memory, electronic hardware, software, and combinations thereof. The system may include a remote server 43, storage devices such as for a database 42, and combinations thereof 41. The application may be configured to transmit data from a first electronic device to a second electronic device over a network. The transmitted data may be through a server. The application may be configured to delete the transmitted data from a first electronic device, a second electronic device, a remote location, a server, a remote memory location, database, and combinations thereof. The deletion from a remote memory location may include a memory not under the control of the first user. For example, the memory location may be associated with a second user and not accessible directly by the first user. The application may include a plurality of applications stored on one or more electronic devices including a first user electronic device, a second user electronic device, a server, and combinations thereof.

As described herein, exemplary embodiments may permit a user to recall or delete a single data item, such as a message, text, file, picture, image, video, and/or audio, a series of data items, select data items, and/or an entire history or exchange with another user. For example, the system may be configured to permit a user to identify and/or search for specific data exchanged with another user and identify the data to be deleted. The system may be configured to permit a user to identify deletion criteria, such as another user, a date, a date range, a file type, key words, or other criteria, and combinations thereof to remove one or more data sent from the user to another user. Exemplary embodiments permit the user to select data to be deleted in one or more ways. For example, each data displayed to the user may have a menu item associated with it to delete that item from the local device or to delete that item permanently from all devices. The deletion menu option may be provided at different levels of the system, such that an individual data item to be deleted or an entire exchange with another user may be deleted. The system may be configured with a user interface that permits a user to search and/or select data for deletion in bulk and/or per sent data item and/or per sent data stream.

The system may permit different levels of granularity by providing different data transmitted with different identifiers. The identifiers may be assigned in different ways. The identifier may be randomly generated and/or may follow a protocol for generating a unique identifier. An exemplary protocol for generating a unique identifier may include a portion of the identifier for different attributes associated with the data and/or sending of the data, such as a portion of the identifier to identify the sending user, the receiving user, the file type, date of send, time of send, data type, other identifying attribute and combinations thereof. The identifier may be assigned by an application run on the local device at the time the data to be sent is created, at the time the data is sent to another user, or by an application run at the remote server when the data is received by the server.

If the identifier includes a scheme based on attributes of the data (such as the user that sent it, the user that received it, the date and time, data type, etc.), the identifier may be used to find and delete data to be deleted. For example, if user A carried on an exchange with user B over a number of days, user A can request the deletion of all of the data sent to user B. If the unique identifier is based in part on the receiving user, then all messages having the portion of the identification number associated with the receiving user may be deleted. Therefore, search criteria to retrieve and delete data may be based on the unique identifier and/or portions thereof.

Although embodiments described herein are generally in terms of deleting a file, other methods to prevent or restrict access to data may alternatively or additionally be used. For example, exemplary embodiments may be used to send instructions from one device to another device over the server or directly to corrupt a file. Exemplary embodiments may be used to send instructions to lock a file or encrypt a file. In an exemplary embodiment, a file may include a flag, bit code, or other imbedded code or signal within the file or data string or associated with the file or data string that may be used to control access to the file or data string.

Although embodiments of this invention have been described with reference to the accompanying drawings, it is to be noted that various changes and modifications will become apparent to those skilled in the art. Such changes and modifications are to be understood as being included within the scope of embodiments of this invention as defined by the appended claims.

The invention claimed is:

1. A method for recalling a message, comprising:
receiving data from a first electronic device associated with a first user at a server;
associating a unique identifier with the data;
sending the data associated with the unique identifier to a second electronic device associated with a second user from the server;
storing the data and the unique identifier on the second electronic device;
receiving a recall request for the data from the first electronic device;
identifying the unique identifier associated with the data;
sending a recall request for the data by the unique identifier to the second electronic device; and
deleting the data associated with the unique identifier from the second electronic device.

2. The method for recalling the message of claim 1, further comprising storing the data and the unique identifier on a memory location associated with the server and deleting the data associated with the unique identifier from the memory associated with the server.

3. The method for recalling the message of claim 1, further comprising storing the data and the unique identifier on the first electronic device and deleting the data associated with the unique identifier from the first electronic device.

4. The method for recalling the message of claim 1, further comprising displaying to the first user through a user interface of the first electronic device information associated with the data.

5. The method for recalling the message of claim 4, further comprising receiving an input from the first user through the user interface indicating the data to be recalled.

6. The method for recalling the message of claim 5, further comprising receiving a request to look up the unique identifier associated with the data to be recalled at the server.

7. The method for recalling the message of claim 6, returning from the server to the first electronic device the unique identifier associated with the data.

8. The method for recalling the message of claim 1, further comprising associating a plurality of unique identifiers to a series of data received from the first electronic device at the server and sent to the second electronic device.

9. The method for recalling the message of claim 8, wherein the plurality of unique identifiers is generated based on an association with the first user and the second user.

10. The method for recalling the message of claim 8, wherein the plurality of unique identifiers are used in a recall request to delete the series of data sent from the first electronic device to the second electronic device.
